(19) United States
(12) Patent Application Publication
(10) Pub. No.: US 2007/0137224 A1
(43) Pub. Date: Jun. 21, 2007

(54) AUTOMATED CONDENSING UNIT TEST APPARATUS

(75) Inventors: Anthony E. Atchison, Paris, AR (US); James R. Clifford, Fort Smith, AR (US); Randy R. Koivisto, Fort Smith, AR (US); Kelvin W. Kleman, Fort Smith, AR (US)

Correspondence Address: HAYNES AND BOONE, LLP, 901 MAIN STREET, SUITE 3100, DALLAS, TX, 75202, US

(73) Assignee: RHEEM MANUFACTURING COMPANY, Atlanta, GA (US)

(21) Appl. No.: 11/677,735

(22) Filed: Feb. 22, 2007

Related U.S. Application Data
(62) Division of application No. 10/910,215, filed on Aug. 3, 2004.

(51) Int. Cl. G01K 13/00; F25B 13/00; F25B 41/00

(52) U.S. Cl. 62/129; 62/160; 62/174; 62/DIG. 17

(57) ABSTRACT

A test module is connectable to the suction line of a condensing unit charged with refrigerant, and also electrically connectable to the unit, and is useable to automatically test for proper operation of the unit without having to connect an external test coil thereto or place pressurized nitrogen therein. After the module is connected to the unit, the unit's compressor is started to operate the unit in an “open loop” manner with no refrigerant recirculation therethrough. The module monitors the suction line pressure. If the sensed pressure reaches a predetermined magnitude within a predetermined time after compressor start-up, the module outputs a first signal indicating proper condensing unit operation. Absent this timely attainment of the predetermined pressure, a second signal is generated to indicate test failure. In the case of a heat pump condensing unit, the module tests for proper heating, cooling and defrost operation.

### CROSS-REFERENCE TO RELATED APPLICATION

This application is a division of copending U.S. application Ser. No. 10/910,215 filed on Aug. 3, 2004 and entitled “Automated Condensing Unit Test Apparatus and Associated Methods”, such copending application being hereby incorporated herein by reference in its entirety.

### BACKGROUND OF THE INVENTION

The present invention generally relates to the testing of refrigerant-based air conditioning equipment and, in a representatively illustrated embodiment thereof, provides apparatus and methods for conducting refrigerant circuit testing of both air conditioning and heat pump system condensing units.

As is well known in the air conditioning art, a condensing unit forms the “outdoor” portion of an overall refrigerant-based air conditioning or heat pump system and is connectable to the “indoor” portion of the system by suitable suction and liquid refrigerant lines. Air conditioning and heat pump system manufacturers typically test their condensing units for proper operation before they leave the factory. Using conventional apparatus and methods, these tests are conducted by connecting the suction and liquid lines of the condensing unit to be tested to an external test coil, with the refrigerant circuit being charged with refrigerant, or connecting the suction line of the uncharged refrigerant circuit to a source of pressurized nitrogen. The condensing unit is then run and various manual cooling or heating and cooling tests are performed on the unit, depending on whether it is part of an air conditioning system or a heat pump system.

Various problems, limitations and disadvantages are typically associated with these conventional condensing unit testing techniques. For example, the utilization of pressurized nitrogen places restraints on the length of run time and the number of cycles a compressor can be run. If these test limits are exceeded, the compressor portion of the tested condensing unit needs to be replaced. Additionally, when heat pump condensing units are being tested using the conventional nitrogen test method, approximately 15% of the condensing units tested are misdiagnosed as having bad reversing valves and are sent out for unneeded repairs. The tests which must typically be performed using the external test coil unavoidably and undesirably introduce the possibility of human error therein. Moreover, the test coil needs to be connected to, and then disconnected from each condensing unit to be tested, thereby undesirably increasing the overall test time.

As can readily be seen from the foregoing, a need exists for improved condensing unit testing apparatus and methods that eliminate or at least substantially reduce the above-mentioned problems, limitations and disadvantages typically associated with conventional test apparatus and methods of the types generally described above. It is to this need that the present invention is primarily directed.

### SUMMARY OF THE INVENTION

In carrying out principles of the present invention, in accordance with a preferred embodiment thereof, specially designed test apparatus and associated methods are provided for testing a condensing unit for proper operation. The condensing unit may be an air conditioning condensing unit (i.e., a “cooling only” unit) or a heat pump condensing unit capable of both heating and cooling. According to a key aspect of the invention, the condensing unit may be quickly and easily tested for proper operation thereof without the necessity of (1) connecting the unit to an auxiliary coil, or (2) placing pressurized nitrogen into the refrigerant circuitry of the unit.

To verify proper operation of a condensing unit having a compressor coupled to a refrigerant circuit portion with refrigerant therein, a test module is provided which has incorporated therein (1) control apparatus operable to generate a pass signal indicative of proper condensing unit operation in response to receipt of a pressure detection signal within a predetermined time after start-up of the unit's compressor, and (2) sensing apparatus operable to sense the pressure within a predetermined interior location of the refrigerant circuit portion of the unit, without recirculation of refrigerant therethrough, and transmit the pressure detection signal to the control apparatus in response to the pressure sensed, during compressor operation without refrigerant recirculation through the refrigerant circuit portion, reaching a predetermined magnitude.

The condensing unit is thus tested during operation of its compressor, with its refrigerant circuit being in an “open loop” mode—i.e., without the recirculation of refrigerant therethrough. Representatively, the liquid line portion of the unit's refrigerant circuit is capped off, and the unit's suction line is coupled to the sensing apparatus during use of the test module.

In an illustrated embodiment thereof, the test module's control apparatus includes a pre-programmed CPU unit coupled to an electrical portion removably connectable to a control portion of the condensing unit and further coupled to a status indicating portion of the test module, and the test module's sensing apparatus includes a pressure manifold having a pressure connector structure coupled thereto and being removably connectable to the suction line, and pressure sensing and transmitting apparatus interconnected between the pressure manifold and the CPU unit. Representatively, this pressure sensing and transmitting apparatus comprises a multi-function pressure transducer having a pressure input coupled to the pressure manifold, and electrical signal output lines coupled to the CPU unit and respectively indicative of 275PSIG and 25 PSIG pressures, and a 15 PSIG pressure switch having a pressure input coupled to the pressure manifold, and an electrical signal output line coupled to the CPU unit.

When the test module is operatively coupled to an air conditioning (i.e., a “cooling only”) condensing unit, a start button portion of the module is depressed. In response, the module first checks the pressure within the condensing unit refrigerant circuit to verify the presence of refrigerant therein. If the presence of refrigerant is not verified (by the generation of an output signal from the pressure switch), the test module prevents start-up of the condensing unit compressor to prevent damage thereto due to lack of refrigerant charge. If the test module confirms the presence of refrigerant within the condensing unit refrigerant circuit, the test module automatically starts the condensing unit compressor. If the 25 PSIG output signal from the pressure transducer is generated within a predetermined time after compressor start-up, the test module generates a pass signal indicative of proper condensing unit operation. If not, the test module generates a fail signal and shuts the compressor down.

When the test module is operatively coupled to a heat pump condensing unit (i.e., one capable of both heating and cooling), the test module first checks for the presence of refrigerant within the refrigerant circuit of the condensing unit as previously described herein. If refrigerant is present, the test module then operates the unit's reversing valve to place the unit in its heating mode and starts the compressor. If the 275 PSIG pressure transducer output signal is then generated within a predetermined time, the test module then automatically generates a pass signal indicative of proper heating operation of the condensing unit. If not, a fail signal is generated.

Next, after a predetermined built-in time delay, the test module subjects the heat pump condensing unit to a cooling test (similar to that described above for an air conditioning condensing unit) and also tests the unit for proper operation of its defrost cycle, automatically generating appropriate “pass” or “fail” signals as the case may be.

According to another feature of the present invention, after the condensing unit is tested the test module is operable to equalize the pressure within the refrigerant circuit portion of the tested condensing unit. When an air conditioning condensing unit has been tested, this pressure equalization is accomplished by opening a normally closed solenoid valve installed in a pressure equalization line interconnected between the suction and liquid lines of the condensing unit. When a heat pump condensing unit has been tested, this pressure equalization is accomplished by appropriately energizing the condensing unit's reversing valve.

### BRIEF DESCRIPTION OF THE DRAWINGS

FIG. 1 is a schematic diagram of a test module embodying principles of the present invention and operatively connected to a condensing unit to test for proper operation thereof;

FIG. 2 (Prior Art) is a schematic diagram illustrating a conventional external coil technique for testing a condensing unit; and

FIG. 3 is an enlarged scale elevational view of a removed cover portion of a module housing structure shown in FIG. 1.

### DETAILED DESCRIPTION

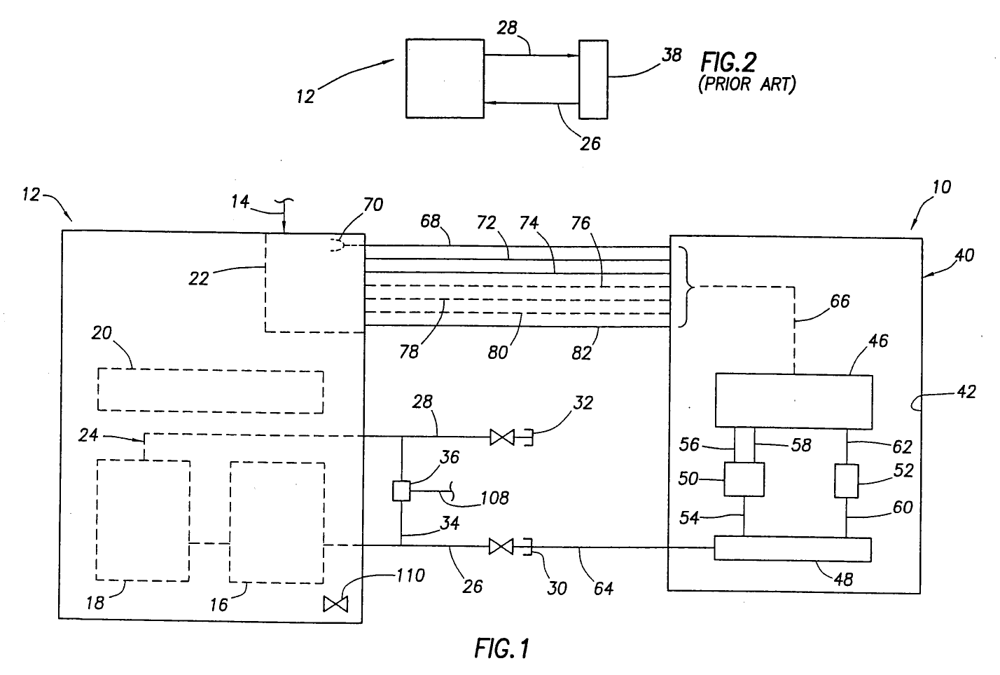

Referring initially to FIG. 1, this invention provides a test module 10 useable to test a condensing unit 12 which may be an air conditioning condensing unit (representatively depicted in schematic form in FIG. 1) which is to be tested for cooling only, or a heat pump condensing unit which is to be tested for cooling, and heating and defrost modes. The condensing unit 12 (the “outdoor” portion of the overall air conditioning or heat pump system) is supplied with suitable electrical power 14 appropriate to the system requirements, and has disposed therein a compressor 16, a coil 18, and a fan 20. Internally mounted within the condensing unit 12 is an electrical control box 22 to which the electrical power 14 is connected. The refrigerant circuit portion 24 within the condensing unit 12 is operationally charged with a suitable pressurized refrigerant, and the circuit portion 24 has a valved suction line 26 and a valved liquid line 28 extending outwardly therefrom. The outer ends of the suction and liquid lines 26,28 are respectively capped off with process fittings 30 and 32 for later connection in the field to the indoor portion (not illustrated) of the overall air conditioning or heat pump system. Optionally, a pressure equalization line 34 having a solenoid valve 36 therein is interconnected between the suction and liquid lines 26,28.

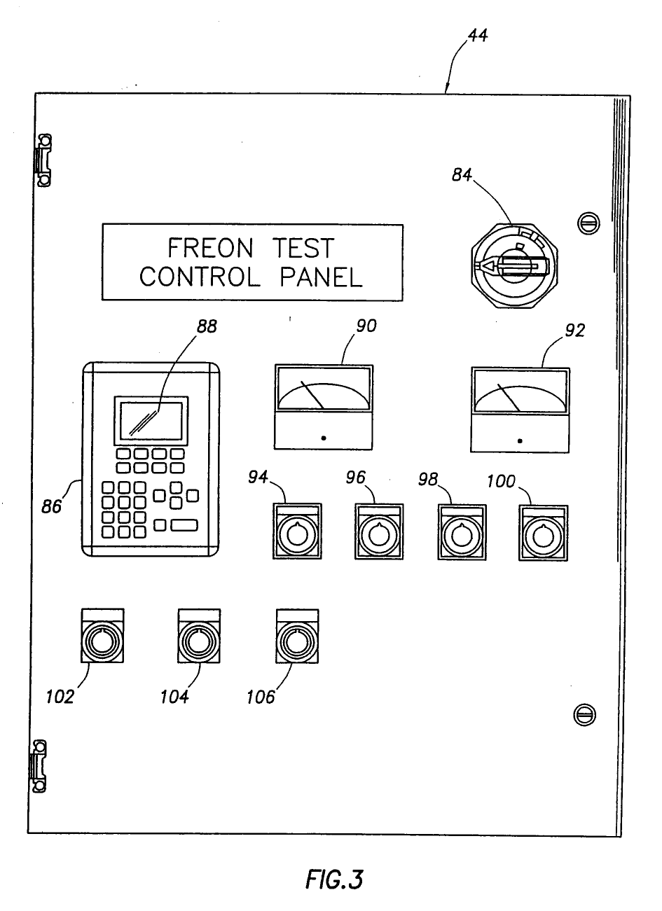

Heretofore, a conventional method of testing a condensing unit such as the unit 12, as schematically depicted in FIG. 2 (Prior Art), was to connect its suction and liquid lines 26,28 to an external test coil 38, with the refrigerant circuit being charged with refrigerant, run the condensing unit, and automatically perform cooling or heating and cooling tests thereon. Another conventional test method (not illustrated herein) was to connect a condensing unit such as the condensing unit 12 to a pressurized supply of nitrogen at suction line 26, run the unit, and then monitor the resulting pressure at the liquid line 28. As is well known, various problems, limitations and disadvantages are typically associated with these conventional testing techniques.

For example, the test utilizing the refrigerant and an external test coil 38 is lengthy, requires several expensive test stations, exposes the system to leaving compressor oil in the external test coil, creates maintenance for removing the oil, and typically requires frequent cleaning to keep air moving over the external test coil. The other conventional method of testing with nitrogen has time and cycle restraints on the length of run time and the number of cycles a compressor can be run. If these limits are exceeded, the compressor 16 needs to be replaced. Additionally, the tests which must typically be performed using the nitrogen unavoidably and undesirably introduce the possibility of human error therein. In either of these two conventional testing techniques two connections must be made to, and later disconnected from, each condensing unit to be tested, thereby undesirably increasing the overall test time. When heat pumps are being tested using this nitrogen-based test method, a substantial percentage of the heat pumps tested are misdiagnosed as having bad reversing valves and are sent for unneeded repairs. Also, this nitrogen testing technique presents the possibility that the compressor can be started under vacuum in the circuit, thereby damaging the compressor.

Referring again to FIG. 1, the present invention takes a different approach in that, utilizing sensed pressure within the suction line 26, the test module 10 automatically performs (1) cooling tests or (2) heating and cooling tests on the condensing unit 12 in an “open loop” configuration in which the liquid line 28 remains capped off and unconnected to an external coil, and the suction line 26 is connected only to a subsequently described pressure sensing portion of the module 10 in a manner such that there is no recirculation of the condensing unit circuit refrigerant during such automatic testing of the condensing unit. Additionally, no nitrogen is introduced into the condensing unit circuit 24 during testing of the unit.

With reference now to FIGS. 1 and 3, the test module 10, which is suitably powered by 110V AC electrical power, includes a housing base portion 40 (see FIG. 1) having an open side 42 covered by an openable control panel door 44 (see FIG. 3). Disposed within the housing base portion 40 are a CPU unit 46 appropriately programmed to control various test and monitoring procedures subsequently described herein, a pressure manifold 48, a multi-function pressure transducer 50, and a 15 PSIG pressure switch 52.

Pressure transducer 50 has (1) a pressure input line 54 coupled to the pressure manifold 48; (2) a first electric signal output line 56 coupled to the CPU 46 and operative to send an electrical signal thereto when, via the pressure input line 54, the pressure transducer 50 senses a 25 PSIG pressure within the pressure manifold 48; and (3) a second electric signal output line 58 coupled to the CPU 46 and operative to send an electric signal thereto when, via the pressure input line 54, the pressure transducer 50 senses a 275 PSIG pressure within the pressure manifold 48. The pressure switch 52 has (1) a pressure input line 60 coupled to the pressure manifold 48; and (2) an electric signal output line 62 coupled to the CPU 46 and operative to send an electric signal thereto when, via the pressure input line 60, the pressure switch 52 senses a 15 PSIG pressure within the pressure manifold 48. A flexible pressure sensing hose 64 is coupled at one end thereof to the pressure manifold 48 and is releasably connectable at its other end to the condensing unit suction line 26 for testing purposes later described herein.

Various electrical lines are connected to the test module housing base portion 40 and, as schematically indicated by the dashed line 66 in FIG. 1, are operatively associated with the CPU unit 46. These electrical lines are removably connectable to the low voltage control box 22 of the condensing unit 12 to be tested and include a current clamp line 68 having a current clamp 70 on an outer end thereof; a compressor run line 72; a common line 74; a 24 volt line 76; a reversing valve line 78; an auxiliary heat relay line 80; and a jumper line 82.

Referring now to FIG. 3, various control and monitoring components are mounted on the control panel door 44 and are operatively associated with the pre-programmed CPU unit 46 schematically depicted in FIG. 1. These components include a power switch 84; an input keypad 86 having a display window 88; a voltage meter 90; an amperage meter 92; a “heat” indicating light 94; a “defrost” indicating light 96; a “cool” indicating light 98; a “fail” indicating light 100; a “start” button 102; a “stop/cancel” button 104; and an “emergency stop” button 106.

### A/C Condensing Unit Cooling Test

When the operator determined, through bar code scanning or manual confirmation, that the unit 12 requiring testing is a non-heat pump condensing unit (i.e., a cool-only unit), the cooling test of the condensing unit 12 is performed by quick-coupling the pressure sensing hose 64 to the suction line 26, connecting the current clamp 70 to the outdoor fan run lead of the condensing unit (not shown), and appropriately connecting the low voltage lines 72,74 and the jumper line 82 to the electrical circuitry within the condensing unit control box 22. The test module start button 102 is then depressed.

According to a feature of the invention, after this initial depression of the start button 102, the module 10 first tests for the presence of pressurized refrigerant in the circuit 24 of the condensing unit 12 being tested, by verifying that the pressure signal 62 (indicative of a positive 15 PSIG pressure created in the pressure manifold 48 by the presence of pressurized refrigerant in the circuit 24) is transmitted to the CPU 46. If the CPU 46 receives the refrigerant verification signal 62 it then automatically starts the condensing unit compressor 16. If the refrigerant verification signal 62 is not received, the CPU 46 prevents the compressor 16 from starting and generates a fault code signal on the key pad display window 88.

If the compressor 16 is started by the test module 10, the compressor 16 is permitted to run for a predetermined time (representatively for about 20-45 seconds) until the resulting pressure draw-down in the suction line 26 (with no recirculation of refrigerant in the circuit 24) creates a 25 PSIG negative pressure in the pressure manifold 48 to thereby cause the pressure transducer 50 to transmit the 25 PSIG output signal 56 to the CPU 46. If this 25 PSIG output signal 56 is transmitted to the CPU 46 within such predetermined time period, through the pre-programmed operation of the CPU 46 the compressor 16 is shut off and the “COOL” indicating light 98 is illuminated to indicate that the cooling test of the condensing unit has been passed. If the normally closed pressure equalization solenoid valve 36 has been installed between the suction and liquid lines 26,28 as shown in FIG. 1, the CPU 46 may also be programmed to open the valve 36 to thereby equalize the pressure between the suction and liquid lines 26,28 at the conclusion of the test thereof.

After the initial test module start-up of the condensing unit compressor 16, if the 25 PSIG transducer output signal 56 is not transmitted to the CPU 46 in the predetermined time (representatively about 20-45 seconds), or the outdoor fan 20 is running backwards as indicated by low current draw, or the current draw on the outdoor fan 20 was excessive, or the current draw on the total system was excessive, the “FAIL” light 100 is automatically illuminated, the compressor 16 is automatically shut down, and a failure message is displayed on the key pad display window 88.

If the 25 PSIG transducer output signal 56 is not generated, but the 15 PSIG pressure switch output signal 62 is, this indicates that the 25 PSIG pressure portion of the transducer 50 is potentially defective, and an appropriate error message is responsively generated on the keypad display window 88 indicating that the safety switch has been activated and to have maintenance check the pressure transducer 50 and circuit.

### Heat Pump Condensing Unit Heating, Cooling and Defrost Tests

When the operator determines, through bar code scanning or manual confirmation, that the condensing unit 12 is a heat pump condensing unit (i.e., connectable in a reversible refrigerant circuit, capable of heating or cooling, and having the indicated reversing valve 110 incorporated therein), a heating test is first performed on the unit 12 by hooking up the pressure sensing hose 64 to the suction line 26, operatively connecting all of the electrical lines 68-82 shown in FIG. 1 to the electrical circuitry in the electrical control box 22, and then pressing the “START” button 102. In response, the module first tests for the presence of pressurized refrigerant in the circuit 24 and then, if the refrigerant presence test is passed, starts the compressor 16 and (by action of the heat pump's reversing valve 110) causes the compressor to build pressure in the suction line 26 (as opposed to drawing down the pressure therein as in the case of a cooling-only condensing unit as previously described herein).

The compressor 16 is permitted to run for a predetermined time (representatively, about 3-5 seconds) to build up suction line pressure until the transducer 50 is activated to transmit its 275 PSIG output signal 58 to the CPU unit 46. The CPU unit 46 then responsively shuts down the compressor 16 and illuminates the “HEAT” light 94 to indicate that the heating test of the unit 12 has been passed. If the 275 PSIG transducer output signal 58 is not generated during this predetermined time period, the CPU unit 46 automatically shuts down the compressor 16 and illuminates the “FAIL” light 100 to indicate that the heating test has been failed.

Next, after a built-in delay, the test module 10 (via the CPU unit 46) automatically subjects the condensing unit 12 to cooling and defrost tests simultaneously. First, the module 10 runs the condensing unit 12 through the same cooling test as previously described for an A/C cooling condensing unit. If the condensing unit 12 fails the cooling test, the “FAIL” light 100 is automatically illuminated. If the condensing unit 12 passes the cooling test, the “COOL” light 98 is automatically illuminated.

Approximately eight seconds after the cooling test has started, the pins on the defrost board of the unit 12 (not shown) are shorted to initiate the built-in defrost cycle of the unit 12. After shorting the pins, the outdoor fan relay goes from closed to open, the current of the outdoor fan portion 20 of the unit 12 is monitored to confirm that it falls to zero, and the auxiliary heat relay is monitored to confirm that goes from open to closed state. At a predetermined time after the pins are shorted the defrost cycle is terminated, the outdoor fan portion is monitored to confirm that the fan current returns to normal operation, and the auxiliary heat relay is monitored to confirm that it cycles back to an open state. If the tester detects that the fan current does not resume, or that the auxiliary heat relay does not return to an open state, the pins are shorted a second time and the confirmation process is repeated. If the unit performs in defrost mode as stated, the “DEFROST” light 96 will be automatically illuminated to indicate that the defrost test has been passed. If not, the “FAIL” light 100 will be automatically illuminated by the preprogrammed CPU unit 46 and the failure mode displayed on the display window 88 of the keypad 86.

Compared to the conventional external coil testing technique shown in FIG. 2 (Prior Art), and the previously described nitrogen-based testing technique, the representative test methods of the present invention described above in conjunction with FIGS. 1 and 3 provide a variety of desirable advantages.

For example, an operator can automatically and safely run tests for both air conditioning units and heat pump units (in heating, cooling and defrost modes) with one touch of a button, which substantially eliminates human error in the testing procedure, while diagnosing the failure mode if a failure occurs in the tested unit. Additionally, the discharge temperatures are 30 to 100 degrees cooler than the existing nitrogen run test. The testing procedures of the present invention also insure proper operation of the reversing valve of a heat pump in both the heating and cooling modes thereof. This substantially eliminates the misdiagnosis of heat pump reversing valves. Moreover, the testing procedures of the present invention are substantially easier and quicker to carry out than the conventional test coil method, thereby reducing overall testing costs. Further, the module has built-in diagnostics for trouble shooting failed components within the module, and the module detects if a factory charge is present in the unit being tested before the compressor is started to eliminate damage to the compressor caused from starting it under a vacuum, which in turn insures that the tested unit leaves the line charged with refrigerant.

The foregoing detailed description is to be clearly understood as being given by way of illustration and example only, the spirit and scope of the present invention being limited solely by the appended claims.

What is claimed is:

1. Testing apparatus for testing a condensing unit having a compressor coupled to a refrigerant circuit portion with refrigerant therein, said testing device comprising:
control apparatus operable to generate a pass signal indicative of proper condensing unit operation in response to receipt of a pressure detection signal within a predetermined time after start-up of said compressor; and
sensing apparatus operable to sense the pressure within a predetermined interior location of said refrigerant circuit portion during operation of said compressor without recirculation of said refrigerant through said refrigerant circuit portion and transmit said pressure detection signal to said control apparatus in response to the pressure sensed, during compressor operation without refrigerant recirculation through said refrigerant circuit portion, reaching a predetermined magnitude.

2. The testing apparatus of claim 1 wherein:
said control apparatus includes a pre-programmed CPU unit.

3. The testing apparatus of claim 1 further comprising:
an electrical portion associated with said control apparatus and removably connectable to said condensing unit.

4. The testing apparatus of claim 1 further comprising:
a pressure connector structure coupled to said sensing apparatus and removably communicatable with said interior location of said refrigerant circuit portion.

5. The testing apparatus of claim 4 wherein:
said refrigerant circuit portion has a suction line portion, and
said pressure connector structure is removably communicatable with the interior of said suction line portion.

6. The testing apparatus of claim 1 wherein:
said control apparatus includes a pre-programmed CPU unit coupled to an electrical portion removably connectable to said condensing unit and further coupled to a status indicating portion of said testing device, and
said sensing apparatus includes a pressure manifold having a pressure connector structure coupled thereto and being removably connectable to said refrigerant circuit portion, and at least one pressure sensing and transmitting device interconnected between said pressure manifold and said CPU unit.

7. The testing apparatus of claim 6 wherein:
said at least one pressure sensing and transmitting device includes a pressure transducer.

8. The testing apparatus of claim 7 wherein:
said pressure transducer is operative to output to said CPU unit a first pressure signal in response to receipt of a first predetermined pressure, and output to said CPU unit a second pressure signal in response to receipt of a second predetermined pressure greater than said first predetermined pressure.

9. The testing apparatus of claim 8 wherein:
said at least one pressure sensing and transmitting device further includes a pressure switch operative to output to said CPU unit a third pressure signal in response to receipt of a third predetermined pressure less than said first predetermined pressure.

10. The testing apparatus of claim 6 wherein:
said at least one pressure sensing and transmitting device includes a pressure switch.

11. The testing apparatus of claim 5 wherein:
each of said at least one pressure sensing and transmitting device has a pressure input portion coupled to said pressure manifold, and an electric output portion coupled to said CPU unit.

12. The testing apparatus of claim 1 wherein:
said control apparatus is further operable to start said compressor, and
said control and sensing apparatus are further operable, prior to compressor start-up, to detect the presence of refrigerant within said refrigerant circuit portion and preclude compressor start-up unless the presence of refrigerant within said refrigerant circuit portion is detected.

13. The testing apparatus of claim 12 wherein:
said sensing apparatus is operable to detect the presence of refrigerant within said refrigerant circuit portion by sensing pressure within said refrigerant circuit portion.

14. The testing apparatus of claim 1 wherein:
said condensing unit is an air conditioning condensing unit, and
said pass signal is indicative of proper cooling operation of said condensing unit.

15. The testing apparatus of claim 1 wherein:
said condensing unit is a heat pump condensing unit, and
said pass signal is indicative of proper cooling operation of said condensing unit.

16. The testing apparatus of claim 1 wherein:
said condensing unit is a heat pump condensing unit, and
said pass signal is indicative of proper heating operation of said condensing unit.

17. The testing apparatus of claim 1 further comprising:
equalization apparatus useable to equalize the pressure within said refrigerant circuit portion subsequent to the testing of said condensing unit.

18. The testing apparatus of claim 1 wherein:
the refrigerant circuit portion includes a condenser coil, and
said testing apparatus is adapted to be connected to the condensing unit, and test it for proper operation, without said condensing unit being connected to a coil other than said condenser coil.

19. The testing apparatus of claim 1 wherein:
said control apparatus and said sensing apparatus are incorporated in a test module which is adapted to be removably and operatively coupled to the condensing unit before the condensing unit is installed in a refrigerant-based air conditioning system as a portion thereof.
